(19) United States
(12) Patent Application Publication
(10) Pub. No.: US 2014/0015679 A1
(43) Pub. Date: Jan. 16, 2014

(54) Specialty Plant Moisture Sensing

(71) Applicant: Green Badge LLC, King of Prussia, PA (US)

(72) Inventor: Jeffrey Campbell, Boise, ID (US)

(21) Appl. No.: 13/940,242

(22) Filed: Jul. 11, 2013

Related U.S. Application Data
(60) Provisional application No. 61/671,729, filed on Jul. 15, 2012.

(51) Int. Cl. G08B 21/20

(52) U.S. Cl. CPC G08B 21/20
USPC 340/604

(57) ABSTRACT

A sensor for monitoring a nursery or specialty plant is disclosed herein. A tethered sensor is placed in a tree's rootball. The sensor is connected to a sensor monitor with a cable that can be disconnected from the sensor. The cable allows the sensor monitor to provide power as needed and to receive sensor readings from the sensor.

### CROSS REFERENCE TO RELATED APPLICATION

The Present Application claims priority to U.S. Provisional Patent Application No. 61/671729, filed Jul. 15, 2012, which is hereby incorporated by reference in its entirety.

### STATEMENT REGARDING FEDERALLY SPONSORED RESEARCH OR DEVELOPMENT

Not Applicable

### BACKGROUND OF THE INVENTION

1. Field of the Invention

The present invention generally relates to moisture sensors for nursery or specialty plants.

2. Description of the Related Art

Large trees or ornamental plants can easily exceed $1,000 to purchase and install, and oftentimes these very expensive plants die from simple under or over watering. Thus, there is a need to greatly reduce this occurrence. However, trying to solve this problem leads to further problems.

### BRIEF SUMMARY OF THE INVENTION

The present invention provides a solution to this problem in a cost effective manner, and addresses the other problems that created by the solution to the problem.

The present invention is preferably an inexpensive moisture sensor on a short tether to an above ground “hub” that determines whether expensive specialty plants/trees/shrubs are properly watered during their initial planting and during the time period that they are guaranteed to survive by a nursery or the like after their initial planting.

The present invention preferably includes a short tethered sensor (soil moisture only) that has a connector on one end. The connector is plugged into a reading/display unit that is preferably battery powered and indicates moisture status (possibly blinking LEDs) and/or transmits moisture status to a person responsible for guaranteeing the plants survival. The hub is preferably battery powered (1 year minimum battery life) and placed above ground on a tree trunk or on a short stake by a shrub and is easily field connected to the sensor. The sensor is preferably designed to be permanently left in the ground while the hub is capable of movement from site to site. A preferred communication protocol for the product is a cell phone modem since the data transmission rate is at most a moisture reading once every few hours. For large nurseries, a dedicated wireless network is preferred.

The use of an integrated sensor allows the sensors to communicate wirelessly to a hub and then on to the internet via a GSM modem and/or displaying the sensor readings for all sensors within range of the hub.

Users of the present invention preferably include high end horticultural market but there are a number of other applications that might be of interest such as dam safety, canal/levy monitoring, pipe leakage detection, spill detection, flooding detection, water infiltration into roadbeds or other structures, cement curing, etc.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is an image of the preferred embodiment of the present invention.

FIG. 2 is an image of an alternative embodiment of the present invention

FIG. 3 is a diagram of the various embodiments of the present invention.

FIG. 4 is an image of tethered sensor and sensor monitor.

FIG. 5 is an image of wireless sensor and wireless sensor hub.

### DETAILED DESCRIPTION OF THE INVENTION

FIG. 1 illustrates a preferred embodiment of the present invention for a newly planted tree 101 with a tethered sensor 100 placed in the tree's rootball 102. The sensor 100 is connected to a sensor monitor 103 with a cable 104 that can be disconnected from the sensor 100. The cable 104 allows the sensor monitor 103 to provide power as needed and to receive sensor readings from the sensor 100. The sensor 100 is at least one, if not more, type of sensor that monitors and maintains plant health, including soil moisture, soil temperature, soil salinity, and/or soil nitrate levels.

The sensor monitor 103 contains a power source, such as batteries, or alternatively the monitor 103 is connected to a power source. The sensor monitor 103 connects directly to the sensor 100 via a cable 104. The sensor monitor 103 contains a microcontroller configured for alarm or threshold levels to be set and warnings, such as blinking lights or an audible tone, which can be generated by the sensor monitor 103. In addition, the sensor monitor 103 is capable of communicating directly using cell phone communications, a local WiFi connection, a wired Ethernet, or other communication avenues.

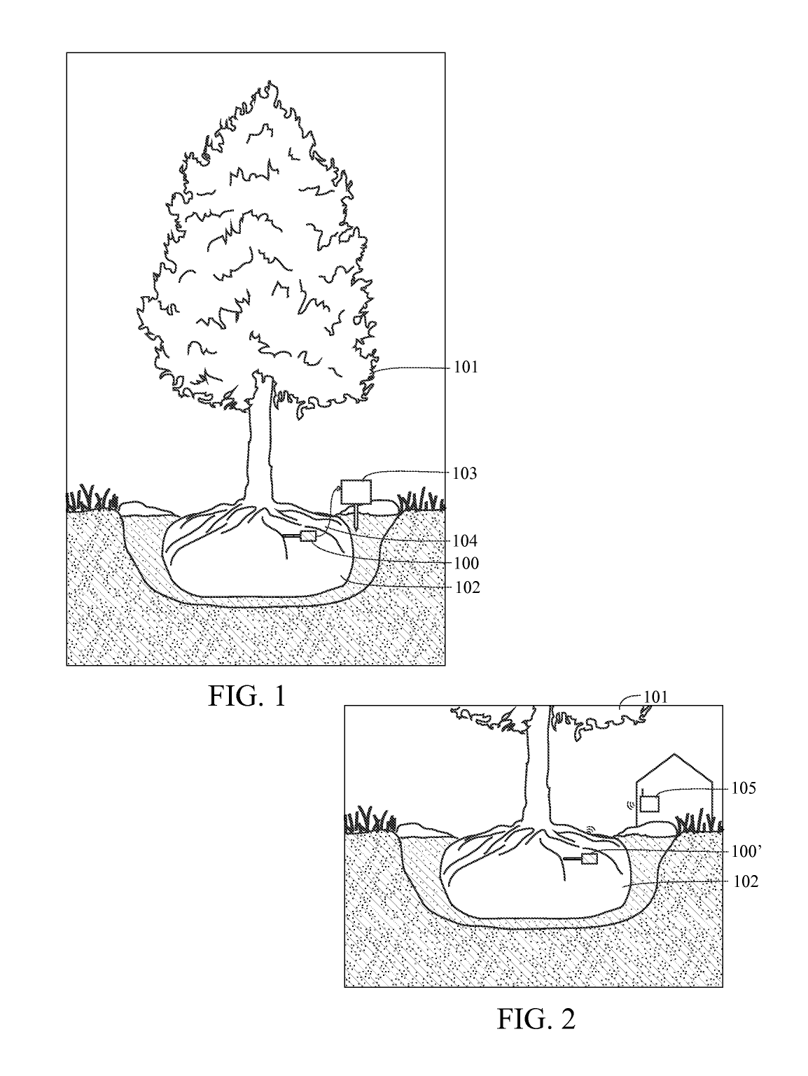

FIG. 2 illustrates an alternative embodiment of the present invention for a newly planted tree 101 with a wireless sensor 100′ placed in the tree's rootball 102. The sensor 100′ preferably contains its own power source (batteries) and a radio transmitter capable of communicating directly with a sensor hub 105. The sensor 100′ is at least one, if not more, type of sensor that monitors and maintains plant health, such as soil moisture, soil temperature, soil salinity, and/or soil nitrate levels.

The sensor hub 105 is configured to receive wireless soil sensor communications from the wireless sensor 100′ as well as display the current sensor level. Optionally, the sensor hub 105 is also configured to show when sensor readings are out of range or in an “alarm” condition. The alarm conditions activate blinking lights or sound an audible ring. The wireless hub 105 is also configured to relay sensor readings using WiFi, Ethernet, cell phone modems or other wireless technologies.

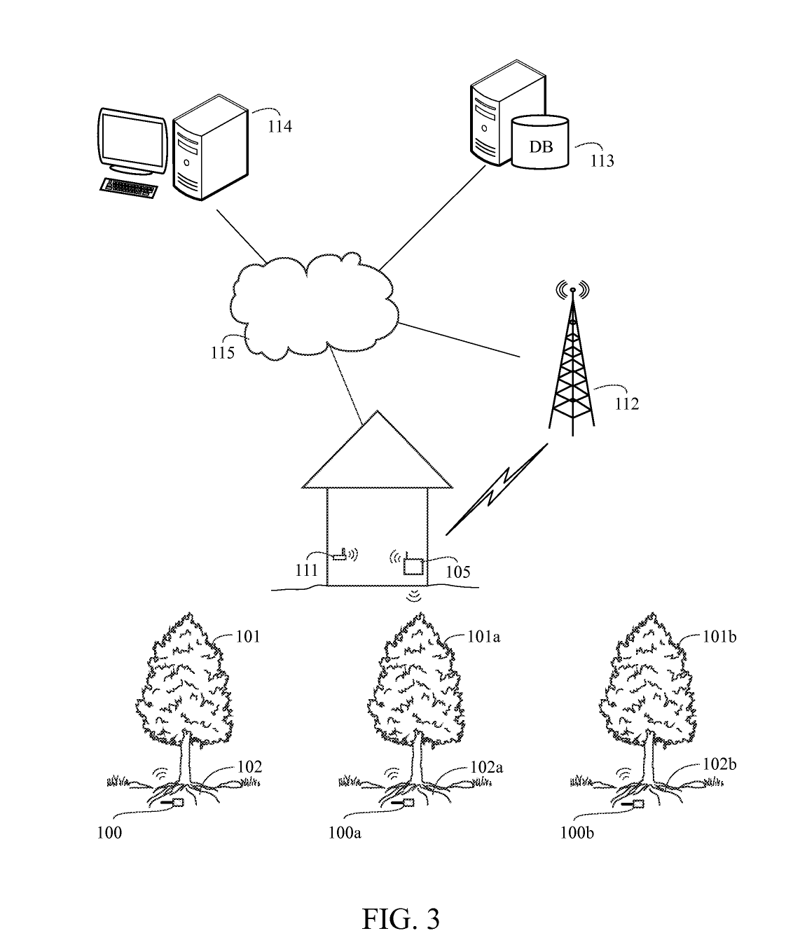

FIG. 3 illustrates various embodiments of the present invention. A wireless sensor hub 105 receives wireless communications from one or more wireless soil sensors 100-100b that are inserted into the rootballs 102-102b of trees 101-101b. The wireless sensor hub 105 communicates wirelessly, using a router 111 or an existing cell phone network 112, sending data over the internet 115 to a central data server 113, or to a local computer 114 or to a display device. The central data location server 113 is configured to automatically generate status indications via a variety of means (text message, email, phone, etc.) and provide data reporting over extended time periods.

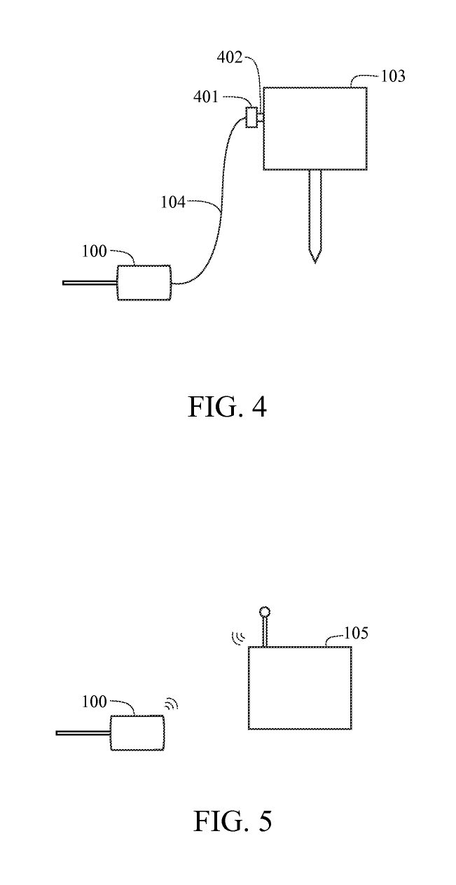

FIG. 4 shows a tethered sensor 100 and sensor monitor 103. The sensor 100 is connected to a sensor monitor 103 via a power and communication cable 104. The monitor 103 has a plug 402 that fits a connector 401 from the cable 104.

FIG. 5 shows an alternative embodiment of the present invention, of a wireless sensor 100 and a wireless sensor hub 105. The wireless hub 105 is configured to receive wireless soil sensor communications from the wireless sensor 100 as well as display the current sensor level and/or showing sensor readings are out of range or in an “alarm” condition. The wireless sensor hub 105 also is configured to relay sensor readings using WiFi, Ethernet, cell phone modems, and other like mediums.

A tethered sensor 100 preferably includes a soil moisture sensor (or other sensor such as temperature, salinity, nitrate, etc. that may be of use in monitoring and maintaining plant health) with a cable equipped with a connector that attaches to a sensor monitor 103. The cable allows the sensor monitor 103 to provide power as needed and receive sensor readings.

The sensor monitor 103 preferably contains a power source (batteries) or is connected to a power source (not shown). The sensor monitor 103 connects directly to a sensor 100 and allows the sensor 100 to be powered and receive sensor measurements. The sensor monitor 103 preferably includes a microcontroller with the ability for alarm or threshold levels to be set and warnings (blinking LED, audible tone, etc.) generated by the device. In addition, the sensor monitor 103 is preferably configured to communicate directly using cell phone communications, a local WiFi connection, a wired Ethernet, or other communication avenues.

A wireless sensor is similar to the tethered sensor but without the cable and equipped with its own power source (batteries) and a radio transmitter configured to communicate directly with the sensor hub 105.

The wireless sensor hub 105 is configured to receive wireless soil sensor communications from the wireless sensor 100 as well as displaying the current sensor level and/or showing sensor readings are out of range or in an “alarm” condition. The wireless sensor hub 105 is also configured to relay sensor readings using WiFi, Ethernet, cell phone modems, etc.

Alternatively, a data management system resides in the Cloud that receives sensor readings from either the sensor monitor 103 or the wireless sensor hub 105 and allows for automated posting of alarm conditions, current readings, or historical reports of sensor data. The system may generate automated notifications in the form of text messages, emails, voice messages, or the like, that indicate current status or alarm conditions. The wireless sensor hub 105 or the sensor monitor 013 alternatively communicate to the Cloud based system utilizing cell phone modem, WiFi, or other wireless link or may utilize a wired connection such as Ethernet.

The present invention may be used with a system and method such as disclosed in Glancy et al., U.S. patent application Ser. No. 12/983,241, filed on Dec. 31, 2010 for an Apparatus And Method For Wireless Real Time Measurement And Control Of Soil And Turf Conditions, which is hereby incorporated by reference in its entirety.

The present invention may be used with a system, sensor and method such as disclosed in Campbell, U.S. Pat. No. 7,482,820 for a Sensor For Measuring Moisture And Salinity, which is hereby incorporated by reference in its entirety.

The present invention may use a chemical sensor probe such as disclose in U.S. Pat. No. 4,059,499 which is hereby incorporated by reference in its entirety.

The present invention may use a chemical sensor probe such as disclose in U.S. Pat. No. 5,033,397 which is hereby incorporated by reference in its entirety.

The present invention may utilize the systems and methods disclosed in Magro et al., U.S. patent application Ser. No. 12/697,226, filed on Jan. 30, 2010, for a Method And System For Monitoring Soil And Water Resources, which is hereby incorporated by reference in its entirety.

The present invention may also utilize the systems and methods disclosed in Magro et al., U.S. patent application Ser. No. 12/911,720, filed on Oct. 25, 2010 for a Method For Soil Analysis, which is hereby incorporated by reference in its entirety.

Magro et al., U.S. patent application Ser. No. 12/698,176, filed on Feb. 2, 2010 for a Method And System For Monitoring Soil And Water Resources is hereby incorporated by reference in its entirety.

Campbell et al., U.S. patent application Ser. No. 12/698,138, filed on Feb. 1, 2010 for a Method, System And Sensor For Performing Soil Measurements is hereby incorporated by reference in its entirety.

Campbell et al., U.S. Pat. No. 8,035,403 for a Wireless Soil Sensor Utilizing A RF Frequency For Performing Soil Moisture Measurements is hereby incorporated by reference in its entirety.

Campbell et al., U.S. patent application Ser. No. 12/697,258, filed on Jan. 31, 2010 for a Method And System For Improving A Communication Range And Reliability Of A Soil Sensor Antenna is hereby incorporated by reference in its entirety.

Campbell et al., U.S. patent application Ser. No. 12/697,264, filed on Jan. 31, 2010 for an Antenna Circuit Matching The Soil Conditions is hereby incorporated by reference in its entirety.

Campbell et al., U.S. patent application Ser. No. 12/697,283, filed on Jan. 31, 2010 for an Adaptive Irrigation Control is hereby incorporated by reference in its entirety.

Campbell et al., U.S. patent application Ser. No. 12/697,281, filed on Jan. 31, 2010 for an Irrigation Interrupter is hereby incorporated by reference in its entirety.

Campbell et al., U.S. patent application Ser. No. 12/697,292, filed on Jan. 31, 2010 for a Wireless Soil Sensor Utilizing A RF Frequency For Performing Soil Moisture Measurements is hereby incorporated by reference in its entirety.

Campbell et al., U.S. patent application Ser. No. 12/697,256, filed on Jan. 31, 2010 for a Method And System For Soil And Water Resources is hereby incorporated by reference in its entirety.

Campbell et al., U.S. patent application Ser. No. 12/697,257, filed on Jan. 31, 2010 for a Method And System For Soil And Water Resources is hereby incorporated by reference in its entirety.

Systems, methods, sensors, controllers and interrupters for optimizing irrigation are disclosed in Campbell et al., U.S. patent application Ser. No. 12/697,258, filed on Jan. 31, 2010, for a Method And System For Improving A Communication Range And Reliability Of A Soil Sensor Antenna, which is hereby incorporated by reference in its entirety.

Likewise, systems, methods, sensors, controllers and interrupters for optimizing irrigation are disclosed in Campbell et al., U.S. patent application Ser. No. 12/697,254, filed on Jan. 31, 2010, for a Method And System For Soil And Water Resources, which is hereby incorporated by reference in its entirety.

Magro et al., U.S. patent application Ser. No. 13/017,538, filed on Jan. 31, 201 for an Automatic Efficient Irrigation Threshold Setting is hereby incorporated by reference in its entirety.

Apruzzese et al., U.S. Provisional Patent Application No. 61/553,237, filed on Oct. 30, 2011, for an Irrigation Controller is hereby incorporated by reference in its entirety.

Sohrabi et al., U.S. Provisional Patent Application No. 61/553,244, filed on Oct. 30, 2011, for an Irrigation Controller is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

I claim as my invention:

1. A portable monitoring system for monitoring soil conditions for a specialty plant, the system comprising:
a specialty plant having a container comprising soil;
a sensor monitor comprising a sensor, the sensor monitoring a soil condition of the soil in the container of the specialty plant;
a measurement hub;
a cable attached to the sensor monitor and the measurement hub.

2. The system according to claim 1 wherein the cable can be connected and disconnected from the measurement hub.

3. The system according to claim 1 wherein the sensor is left permanently in place and the measurement hub is moved from one site to another site.

4. The system according to claim 1 wherein the sensor measures soil moisture.

5. The system according to claim 1 wherein the sensor measures soil nutrients.

6. The system according to claim 1 wherein the sensor measures parameters indicative of the health of the specialty plant.

7. The system according to claim 1 wherein the measurement hub comprises at least one of a plurality of display lights or a plurality of audible tones that provide indication of the measurement level.

8. The system according to claim 1 wherein the measurement hub communicates wirelessly to a centralized data location to provide status indication.

9. The system according to claim 1 wherein the measurement hub communicates wirelessly over existing cell phone networks.

10. The system according to claim 8 wherein the central data location is configured to automatically generate status indications through a plurality of means comprising at least one of text message, email, phone, and provide data reporting over extended time periods.

11. A soil sensor with attached cable that connects directly into a sensor monitor, wherein the soil sensor measures soil moisture, temperature, salinity, nutrients levels or other parameters associated with plant health, environmental monitoring, or earth structures.

12. The soil sensor according to claim 11 wherein the sensor monitor is designed for the monitoring of flood potential, water intrusion into dams, levies, road fill material, or other geotechnical applications as well as in environmental monitoring.

13. The soil sensor according to claim 11 wherein the soil sensors measure values and alarm conditions utilizing at least one of lights or speaker output.

14. The soil sensor according to claim 11 further comprising means for communicating wirelessly, or wired to the cloud and a data storage/processing routine or a local computer or display device to accomplish similar functions.

15. A portable monitoring system for monitoring soil conditions for a specialty plant, the system comprising:
a specialty plant having a container comprising soil;
a wireless soil sensor configured for monitoring of the health of the specialty plant, the wireless soil sensor positioned within the container.
a wireless hub configured receiving wireless communication from one or more wireless soil sensors having means to indicate measured values and alarm conditions utilizing lights or speaker output, wherein the wireless hub further comprises means for communicating wirelessly, or wired to the cloud and a data storage/processing routine or a local computer or display device to accomplish similar functions.

16. The system according to claim 15 wherein the system is configured for the monitoring of flood potential, water intrusion into dams, levies, road fill material, or other geotechnical applications as well as in environmental monitoring.

17. The system according to claim 15 wherein the system is configured for the monitoring of flood potential, water intrusion into dams, levies, road fill material, or other geotechnical applications as well as in environmental monitoring.
